(19) United States
(12) Patent Application Publication
(10) Pub. No.: US 2015/0283737 A1
(43) Pub. Date: Oct. 8, 2015

(54) METHOD FOR INJECTING THIN PLASTIC PARTS

(71) Applicant: VALEO VISION, Bobigny Cedex (FR)

(72) Inventor: Laurent Luc Barre, Hochfelden (FR)

(21) Appl. No.: 14/436,596

(22) PCT Filed: Oct. 29, 2013
(86) PCT No.: PCT/EP2013/072654

§ 371 Date: Apr. 17, 2015

(30) Foreign Application Priority Data
Oct. 30, 2012 (FR) 1260379

(51) Int. Cl. B29C 45/00; C08K 3/34; C08K 7/14

(52) U.S. Cl. CPC B29C 45/0001; C08K 7/14; C08K 3/34; B29K 2023/04; B29K 2023/10

(57) ABSTRACT

A process for injecting a plastic part by means of an injection unit, the process comprising the following steps: a mixture comprising pellets of a thermoplastic polymer and pellets of a peroxide is produced, the mixture comprising between 0.5% and 10% by weight of peroxide; the mixture is introduced into the inlet of the plastic injection unit; the mixture is conveyed in the injection unit, while gradually raising the temperature of the mixture during the displacement thereof in the injection unit; the mixture is injected, through the outlet of the injection unit, into the mold.

The present invention relates to the field of the injection of plastic, in particular for manufacturing a plastic part for a motor vehicle optical device.

A unit for injecting plastic is known from the prior art which has a barrel comprising a material inlet and outlet and also a reciprocating screw housed in the barrel. This screw, of worm screw type, is used for mixing and for conveying the plastic from the material inlet to the material outlet, then for injecting the material into a mold.

The plastic is introduced into the injection unit in the form of plastic pellets. The term pellets is understood to mean elements of which the size is greater than around 0.5 mm, preferably greater than 1 mm, more preferably still equal to around 2 mm.

Additives, such as dyes, plasticizers, etc. may also be introduced into this unit.

Yet, it is increasingly sought to reduce the amount of plastic used to produce a given part, and this in order to reduce the production costs and the weight of the part, while retaining good mechanical properties of the part.

However, when it is desired to reduce the thickness of the walls of the part, it is necessary for the cavities of the molds into which the material is injected to be thinner. Yet these thinner cavities present greater resistance to the flow of the molten plastic. This will require higher injection pressures, which calls for injection units that are more powerful and often larger.

In order to avoid increasing the pressure for a given injection unit, it is possible to reduce the viscosity of the injected plastic. However, this viscosity reduction during the injection is often carried out at the expense of the mechanical properties of the part once cooled.

It may be envisaged to carry out a multipoint injection of the plastic into the mold without modifying the viscosity of the injected plastic. However, this solution may result in the formation of lines referred to as weld lines which may weaken the part. Furthermore, these weld lines are often esthetically unacceptable.

The objective of the invention is to propose a process for injecting a plastic part that makes it possible to produce a plastic part, the thickness of the wall of which is reduced, and which retains good mechanical properties.

For this purpose, one subject of the invention is a process for injecting a plastic part by means of an injection unit comprising a material inlet, a material outlet toward a mold and means for conveying material between the material inlet and outlet, said process comprising the following steps:

a mixture comprising pellets of a thermoplastic polymer and pellets of a peroxide is produced, the mixture comprising between 0.5% and 10% by weight of peroxide;

the mixture is introduced into the inlet of the plastic injection unit;

the mixture is conveyed in the injection unit, while gradually raising the temperature of the mixture during the displacement thereof in the injection unit, the temperature progression being such that at least 90% by weight of the peroxide is decomposed before the mixture leaves the injection unit;

the mixture is injected, through the outlet of the injection unit, into the mold.

Owing to the process of the invention, the peroxide and the plastic introduced in the form of pellets into the injection unit are reacted.

By applying a gradual increase in the temperature of the mixture during the displacement thereof in the injection unit, a temperature gradient is created, within the injection unit, between the inlet and outlet of the unit; this is also referred to as a temperature or heating profile. In the present case, between the inlet and outlet of the injection unit, the temperature profile is increasing.

The temperature at the start of the heating profile is selected so as to enable the initiation of the reaction between the peroxide and the plastic as early as possible in the injection unit in order to give rise to the reactions and the effects of distributing the heterogeneous mixture as early as possible in the injection unit conveying means, for example the flights of a worm screw.

Yet, in view of the amount of peroxide present in the mixture, the size of the pellets and the temperature profile, the mixture obtained in the injection unit is physically heterogeneous, that is to say that not all the plastic reacts with the peroxide: only the regions of direct contact between the peroxide and the plastic enabling the reactions between the two compounds. Therefore, at the outlet of the injection unit, there remains a fraction of the plastic that has never been in contact with the peroxide. The fraction of plastic that reacts with the peroxide and fraction of plastic that has never been in contact with a peroxide therefore have different physical properties.

The injection unit is generally divided into three successive zones: a feed zone close to the material inlet, a compression zone and a homogenization zone close to the material outlet.

In the feed zone, a more fluid phase is formed which is present in a low volume in the mixture. This more fluid phase is mainly formed by the plastic and the peroxide that has reacted at the surface with the plastic of the pellets by breaking the polymer chains, for example through the middle of the polymer chain, in particular via β scission reactions. This phase is more fluid than the phase formed by the plastic that has not reacted with the peroxide.

Thereafter, the conveying, also referred to as transporting, and the mixing of the mixture along the screw leads to a shear spreading of the more fluid phase and also a distribution of the peroxide that has not yet reacted with the plastic. Thus, the peroxide that has not reacted will come into contact with more plastic and react with the latter, increasing the volume of the more fluid phase. At the same time, this more fluid phase tends to coat the plastic that has not yet come into contact with the peroxide.

The reaction of the peroxide with a portion of the plastic reduces the viscosity of the mixture by forming, between the plastic pellets, a film having a viscosity lower than the viscosity of the plastic. This film corresponds to the more fluid phase. This film will act as a lubricant in the mold during the injection of the mixture into the mold. The mixture may therefore be injected into a mold in order to form a part of reduced thickness, for example of less than 2 mm, without it being necessary to exert a very high pressure during the injection of the mixture into the mold. Moreover, since the mixture is more fluid, it may fill the cavity of the mold more easily.

However, as not all the plastic reacts with the peroxide, the injected part retains mechanical properties similar, or even identical, to those of a part without addition of peroxide.

Indeed, owing to the heterogeneity of the mixture, the mechanical properties of the cooled mixture are not degraded in proportion to the reduction in viscosity, as in homogeneous mixtures.

After injection, during the cooling of the plastic part, the decomposed peroxide continues to react with the polymer chains and forms a crosslinking between the chains, which also makes it possible to improve the mechanical properties of the part once cooled.

Thus, by going against what is generally practiced in the field of the injection of plastic, that is to say the search for mixtures that are as homogeneous as possible, the process of the invention makes it possible to manufacture, in a standard injection unit, a thin plastic part, the mechanical properties of which after injection and cooling are not very degraded or are not degraded at all, which has a homogeneous surface appearance.

The injection process may moreover comprise one or more of the following features, taken alone or in combination:

The size of the plastic and peroxide pellets are similar. Separation phenomena of the two compounds, which could occur in the presence of pellets of different sizes, are thus reduced. Furthermore, the distribution of the mixture is preserved without having segregation due to gravity or to electrostatic forces between pellets of different nature.

The size of the pellets is greater than 0.5 mm, preferably greater than 1 mm, more preferably still equal to around 2 mm. It is therefore possible to use pellets of standard size for the injection of plastic. This process does not therefore generate additional costs linked to pellets of particular size.

The mixture comprises between 0.5% and 5% by weight of peroxide. The lowering of the viscosity of the mixture is thus further favored, together with the retention of the mechanical properties of the polymer. For example, in order to produce a motor vehicle headlamp housing, it is possible to use a mixture comprising 1% to 1.5% by weight of peroxide.

The means for conveying the mixture in the injection unit comprise a worm screw. A standard injection unit comprising simple and effective conveying means is thus used. These means for conveying the mixture are also means for mixing the mixture in the injection unit.

At least 95% by weight, preferably at least 98% by weight, of the peroxide is decomposed before the mixture leaves the injection unit. The efficiency of the process is thus improved and the amount of peroxide may be advantageously reduced. The reaction between the peroxide and the plastic is therefore thoroughly initiated in the injection unit.

The injection unit comprises at least two heating bands intended for heating the mixture contained in the injection unit, between the first heating band positioned close to the inlet of plastic into the injection unit and the outlet of plastic from the injection unit, the temperature rise is between 20° C. and 60° C. For example, the temperature profile applied by the heating bands of the injection unit is an increasing temperature profile ranging from 200° C. to 225° C. Owing to this temperature rise, a heterogeneous mixture is obtained in the injection unit.

The time interval between the mixture entering and leaving the injection unit is less than 15 minutes, preferably less than 10 minutes. The peroxide may decompose and react with the plastic in order to reduce the viscosity of the mixture in the injection unit.

The plastic is selected from polypropylene, polyethylene, polyethylene terephthalate and polybutylene terephthalate. These plastics are commonly used, in particular for the manufacture of motor vehicle parts.

The peroxide is selected from the peroxides for which the 10-hour half-life temperature is greater than or equal to 90° C., preferably greater than or equal to 110° C. The 10-hour half-life temperatures are selected as a function of the plastic used. Among the peroxides having a half-life temperature greater than 90° C., mention may be made of tert-alkyl peroxyesters, di-(tert-alkyl) peroxyketals and di-tert-alkyl peroxides. The 10-hour half-life temperature is understood to mean the temperature at which 50% of the peroxide is decomposed after 10 hours.

The mixture also comprises a reinforcement of the plastic, for example talc or glass fibers. The reinforcement makes it possible to increase the mechanical properties of the molded part.

Another subject of the invention is a plastic part obtained by injection molding, having, on the micrometer scale, at least two phases, a first phase being distributed in the part in the form of grains, a joining phase coating and joining the grains of the first phase.

According to one embodiment of the invention, the joining phase exhibits crosslinking. For the purposes of the invention, it is considered that the joining phase exhibits crosslinking, since the crosslinking of this phase is greater than that of a polymer that has not reacted with the peroxide.

In one advantageous example, this crosslinking forms a continuous network throughout the joining phase.

According to one embodiment of the plastic part according to the invention, the joining phase exhibiting crosslinking as stated in the paragraph above, certain crosslinked chains of the joining phase form an interphase between the joining phase and the first phase, these chains being connected to the polymer chains of said first phase.

The expression “micrometer scale” is understood to mean dimensions of less than a millimeter, preferably of the order of several hundreds of μm, or even of several tens of μm.

The microstructure of the plastic part may in particular be observed using an atomic force microscope (AFM) in “tapping” mode, i.e. in amplitude modulation made in which the cantilever is vibrated at its natural resonance frequency with a certain amplitude. When the tip mounted at the end of the cantilever interacts with the surface of the part, its amplitude is modified. The modification of the amplitude is a representation of the elasticity of the material. It is therefore possible to obtain a two-dimensional representation of the nature of the materials present in the part studied.

The part may be obtained by a process as defined above.

According to embodiments of the invention, the part according to the invention may be a motor vehicle part, in particular a motor vehicle luminous device part, in particular a road lighting device, a signaling device or an interior lighting device; the road lighting device may be a vehicle headlight, also referred to as a vehicle headlamp; the signaling device may be a rear signaling light, in particular a rear signaling light that carries out a stop light, position light, directional indicator and/or reversing indicator function, or else a rear signaling light that carries out a high mount stop light function; the interior lighting device may in particular be a dome light or else a side fixture, for illuminating the passenger compartment of the motor vehicle.

In one embodiment, this motor vehicle luminous device part is a shield or a housing of this motor vehicle luminous device, in particular a vehicle headlight or rear light shield or housing. The part according to the invention is particularly advantageous within the context of walls of large surface areas, since the walls may be thinner for a solidity equivalent to conventional parts. Consequently, even more significant savings in weight and material are obtained for these walls, in particular for shields and even more for housings of light devices, especially for housings of headlights or rear signaling lights.

Another subject of the invention is a motor vehicle luminous device comprising a part according to the present invention, it being possible for this luminous device to be in particular a road lighting device, a signaling device or an interior lighting device. The road lighting device may be a vehicle headlight, also referred to as a vehicle headlamp; the signaling device may be a rear signaling light, in particular a rear signaling light that carries out a stop light, position light, directional indicator and/or reversing indicator function, or else a rear signaling light that carries out a high mount stop light function; the interior lighting device may in particular be a dome light or else a side fixture, for illuminating the passenger compartment of the motor vehicle.

Another subject according to the invention is a motor vehicle comprising a part and/or a luminous device according to the present invention.

According to one embodiment of the invention, the injection process according to the invention is a process for injecting a plastic part according to the invention.

Examples of Peroxides that can be Used According to the Present Invention

| | | 10-hour half-life |
|---|---|---|
| Family | Compounds | temperature (° C.) |
| tert-alkyl | OO-t-amyl-O-(2-ethylhexyl) | 98 |
| peroxyesters | monoperoxycarbonate | |
| | OO-t-butyl-O-isopropyl | 99 |
| | monoperoxycarbonate | |
| | OO-t-butyl-O-(2-ethylhexyl) | 100 |
| | monoperoxycarbonate | |
| | t-amyl peroxybenzoate | 100 |
| | t-butyl peroxyacetate | 102 |
| | t-butyl peroxybenzoate | 104 |
| di(tert-alkyl) | 1,1-di(t-amylperoxy)cyclohexane | 93 |
| peroxyketals | 1,1-di(t-butylperoxy)-3,3,5- | 96 |
| | trimethylcyclohexane | |
| | 1,1-di(t-butylperoxy)cyclohexane | 97 |
| | ethyl 3,3-di(t-amylperoxy)butyrate | 112 |
| | ethyl 3,3-di(t-butylperoxy)butyrate | 114 |
| di(tert-alkyl) | dicumyl peroxide | 117 |
| peroxides | | |

The invention will be better understood on reading the description which follows, given solely by way of example and with reference to the drawings in which:

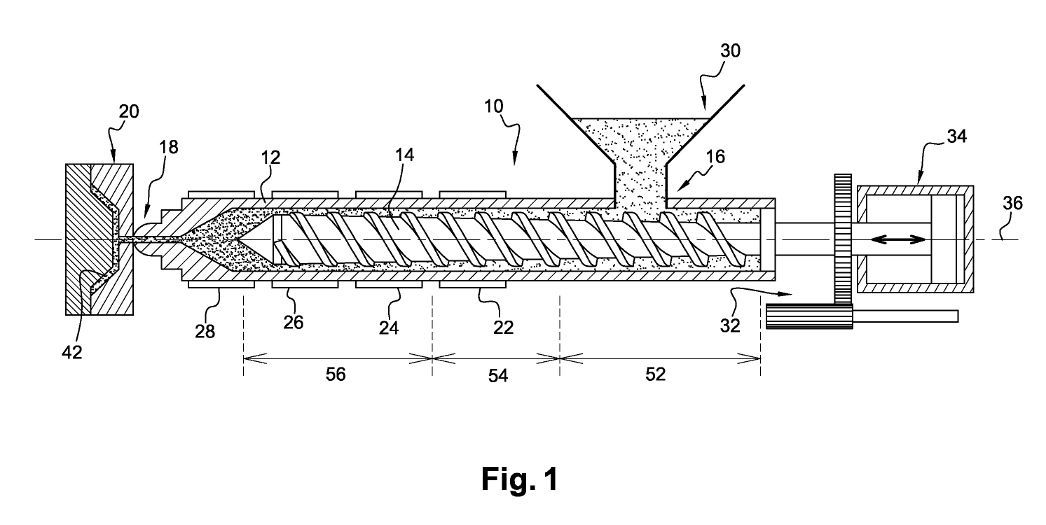

FIG. 1 is a cross-sectional view of an injection unit that makes it possible to carry out the process of the invention;

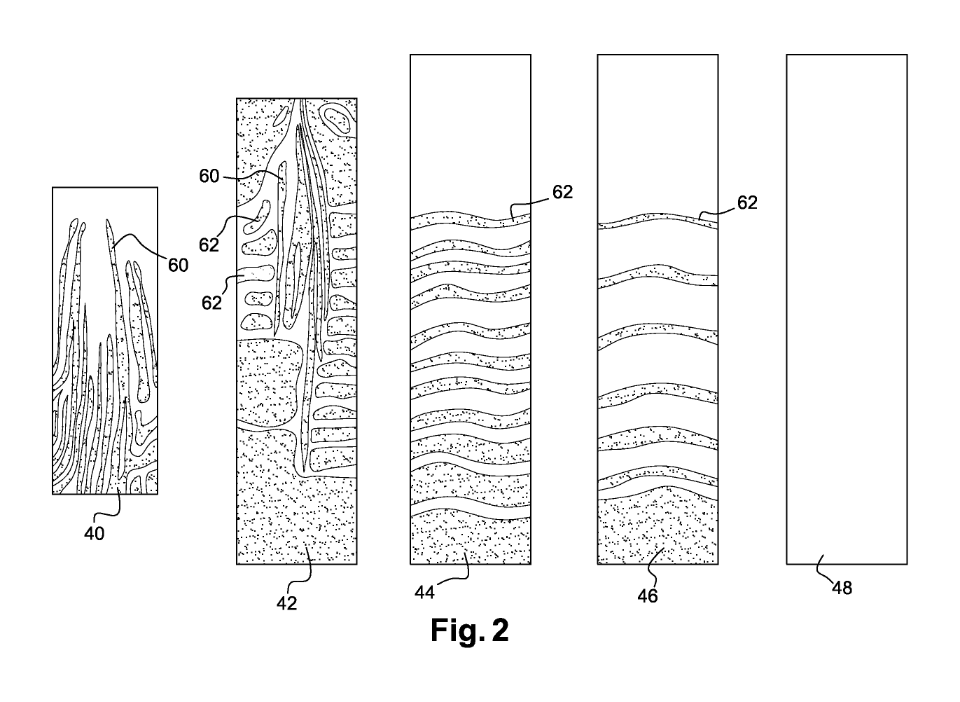

FIG. 2 presents five plastic parts, four of which are obtained by the process of the invention.

FIG. 1 represents a cross-sectional view of a plastic injection unit 10. This unit 10 comprises a barrel 12 of substantially cylindrical shape and a worm screw 14 rotatably mounted in the barrel 12. The worm screw 14 comprises an axis of rotation 36, represented by a dot and dash line in FIG. 1. This axis 36 is generally coincident with the axis of symmetry of the barrel 12.

The barrel 12 comprises an inlet 16 and an outlet 18 toward a mold 20. The injection unit 10 also comprises, surrounding the outer surface of the barrel 12, conventional heating bands 22, 24, 26, 28. There are four of these bands 22, 24, 26, 28 in this embodiment which is given solely by way of example.

The worm screw 14 forms, in this embodiment, means for conveying the mixture in the injection unit 10 and also mixing means.

In order to facilitate the introduction of the mixture to be injected, the inlet 16 comprises a hopper 30.

Owing to the heating bands 22, 24, 26, 28, it is possible to gradually raise the temperature of the mixture during the displacement thereof in the injection unit 10. Indeed, each of the bands may be regulated at a setpoint temperature different from the temperature of the other bands. In the present case, as it is desired to increase the temperature of the mixture as it progresses through the injection unit 10 toward the outlet 18, the setpoint temperature will increase from band 22 to band 28. Therefore, a fixed temperature profile is imposed in the barrel 12 of the injection unit 10.

The injection unit 10 also comprises conventional means 32 for rotating the worm screw 14 about the axis of rotation 36 and also means 34 for translating the worm screw 14 parallel to the axis of rotation 36.

Two examples of the process according to the invention, carried out using the injection unit 10, will be described below.

### EXAMPLE 1

### Mixture of Polypropylene Comprising 30% by Weight of Glass Fiber with 5% by Weight of Dicumyl Peroxide

In this example, the internal diameter of the barrel 12 is 35 mm.

Polypropylene pellets of cylindrical shape having a height of 2 mm and a diameter of 1.5 mm comprising 30% by weight of glass fiber are mixed with 5% by weight of dicumyl peroxide pellets of the same size.

The mixture is introduced into the hopper 30. At the foot of the hopper 30, i.e. at the inlet 16 of the barrel 12, the temperature setpoint of the zone experienced by the mixture is at around 50° C.

The heating bands 22, 24, 26, 28 make it possible to define a temperature profile within the barrel 12.

Between the inlet 16 and the outlet 18 of the barrel 12, three zones can be defined: a first zone referred to as the feed zone 52 located close to the inlet 16 of the barrel 12, a second zone referred to as the compression zone 54 and a third zone referred to as the homogenization zone 56 located close to the outlet 18 of the barrel 12.

The temperature in the feed zone 52 is around 200° C., it is around 215° C. in the compression zone 54 and around 225° C. in the homogenization zone 56.

After a residence time in the injection unit 10 of 3 minutes, 5 minutes and 7 minutes and 30 seconds, respectively around 88%, around 97% and at least 99.5% of the dicumyl peroxide has been decomposed before injection.

During the injection into the mold 20, the mixture has a temperature of around 220° C.

The residence time, i.e. the time interval between the mixture entering and leaving the injection unit is 7 minutes 30 seconds.

### EXAMPLE 2

### Mixture of Polypropylene Comprising 40% by Weight of Talc with 2% by Weight of Dicumyl Peroxide

Polypropylene pellets of substantially cubic shape having sides of 2 mm comprising 40% by weight of talc are mixed with 2% by weight of dicumyl peroxide pellets of the same size.

The other steps of the process are similar to the steps described in example 1.

After a residence time in the injection unit 10 of 3 minutes, 5 minutes and 7 minutes and 30 seconds, respectively around 88%, around 97% and at least 99.5% of the dicumyl peroxide has been decomposed.

### Comparison of Mixtures of Polypropylene Comprising 30% by Weight of Glass Fibers and 0%, 2% and 5% by Weight of Dicumyl Peroxide.

The table below compares the injection pressure required for injecting a mixture into a mold and producing a part having a thickness of 2.25 mm over a length of 300 mm, all the other parameters being constant, and also the elastic modulus of the part once cooled.

| | | Polypropylene (30% | |
|---|---|---|---|
| | Polypropylene | by weight of | Polypropylene (30% |
| | (30% by | glass fiber) + | by weight of glass |
| | weight of | 2% by weight | fiber) + 5% by weight |
| | glass fiber) | of dicumyl peroxide | of dicumyl peroxide |
| Injection | 120 | 70 | 55 |
| pressure | | | |
| (bar) | | | |
| Elastic | 4300 | 4100 | 3800 |
| modulus | | | |
| (MPa) | | | |

It is observed that the pressure needed to inject the plastic into the mold is significantly reduced while the mechanical property loss is relatively low; the mechanical loss is not proportional to the pressure reduction.

### Comparison of Mixtures of Polypropylene Comprising 40% by Weight of Talc and 0%, 2% and 5% by Weight of Dicumyl Peroxide.

The table below compares the injection pressure required for injecting a mixture into a mold and producing a part having a thickness of 2.25 mm over a length of 300 mm, all the other parameters being constant, and also the elastic modulus of the part once cooled.

| | | Polypropylene (40% |
|---|---|---|
| | Polypropylene | by weight of talc) + |
| | (40% by | 2% by weight of |
| | weight of talc) | dicumyl peroxide |
| Injection | 120 | 64 |
| pressure | | |
| (bar) | | |
| Elastic | 1795 | 1780 |
| modulus | | |
| (MPa) | | |

It is understood that owing to the process of the invention, it is possible to produce thinner plastic parts while retaining a good mechanical strength of the molded part, which makes it possible to lighten the weight of the components and therefore, in the case of motor vehicle parts, to reduce the fuel consumption of the vehicle.

FIG. 2 presents five parts 40, 42, 44, 46, 48, four of which are obtained according to the process defined above. From left to right, the mixture of polypropylene comprising 30% by weight of glass fibers respectively comprises 0%, 1%, 2%, 3% and 5% by weight of dicumyl peroxide (the part 40 is not therefore manufactured according to the process of the invention).

It is observed that the surface appearance of the parts is more homogeneous when the amount of peroxide increases in the mixture. Thus, in FIG. 2, on going from left to right, i.e. when the dicumyl peroxide content of the mixture increases, the appearance problems, namely the flow lines 60 and the appearances of wavelets 62, are reduced. It is also observed that without the addition of peroxide in the mixture, it is not possible to produce a part having a length of 300 mm with an injection pressure operating with the same temperatures described above.

The results are almost identical when a worm screw 14 having a diameter of 25 mm or 50 mm is used.

Generally, the crosslinking of a part according to the invention or of a part obtained by a process according to the present invention may be evaluated by the following method. For a given set of polymer(s), the degree of crosslinking D may be measured by the solubility of the polymer in a solvent. Since the polymer is soluble in solvent, the crosslinked portions will, themselves, be insoluble.

By considering only the mass of the surface thickness of the polymer:

D=weight of the treated polymer that is insoluble in a solvent/total weight of the polymer.

For example, the degree of crosslinking of the polypropylene may be measured as follows:

D=weight of polypropylene that is insoluble in xylene at 60° C./total weight of polypropylene.

Use may also be made, for polypropylene, of decahydronaphthalene, at temperatures above 130° C.

Finally, the portion of polypropylene that is insoluble corresponds to the crosslinked fraction. According to the invention, this crosslinked fraction is the fraction which has reacted with the peroxide, i.e. the joining phase and optionally the interphase between the joining phase and the first phase.

If this method for measuring the degrees of crosslinking is applied for a part obtained in a different way, with an injection process using an injection unit comprising a material inlet, a material outlet toward a mold and means for conveying the material between the material inlet and outlet, this process comprising a step of introducing pellets of a given thermoplastic polymer, not mixed with peroxide, for example polypropylene, a step of conveying the plastic into the injection unit, while gradually raising the temperature of the mixture during the displacement thereof in the injection unit, and a step of injecting this material, through the outlet of the injection unit, into the mold, then a reference degree of crosslinking D₀ is obtained.

By using this method of measuring the degree of crosslinking on a part according to the invention or of a part obtained by a process according to the present invention, in which the polymer is identical to that used for measuring the reference degree of crosslinking D₀, a first degree of crosslinking D₁ is obtained.

It will then be observed that the first degree of crosslinking D₁ is greater than the reference degree of crosslinking D₀. An increased crosslinking will therefore be observed in the part according to the invention compared to a part obtained by another process.

Parallelepipedal parts have been represented, but the process may of course be used to produce parts of complex shape. For example, it is possible to produce plastic parts for a motor vehicle lighting and/or signaling device such as a headlight shield, a headlight housing, a lamp-holder, or else housings of air conditioning systems.

Thus, owing to the process of the invention, in particular in the case of a headlight shield and even more of a housing of a vehicle luminous device, in particular of a lighting and/or signaling device, in particular of a headlight, since these parts have large surface areas, it is possible to significantly reduce the weight of the part. This weight reduction makes it possible to decrease the production costs, by reducing the amount of material used, and also the fuel consumption of a vehicle to which this lighting and/or signaling device is intended to be fitted.

Owing to the reduced viscosity of the mixture to be injected, it is also possible to increase the spacing between two injection points in multipoint injection.

1. A process for injecting a plastic part by means of a plastic injection unit comprising a material inlet, a material outlet toward a mold and means for conveying material between said material inlet and said material outlet, wherein said process comprises the following steps:
a mixture comprising pellets of a thermoplastic polymer and pellets of a peroxide is produced, said mixture comprising between 0.5% and 10% by weight of said peroxide;
said mixture is introduced into said material inlet of said plastic injection unit;
said mixture is conveyed in said plastic injection unit, while gradually raising the temperature of said mixture during the displacement thereof in said plastic injection unit, the temperature progression being such that at least 90% by weight of said peroxide is decomposed before said mixture leaves said plastic injection unit;
said mixture is injected, through said material outlet of said plastic injection unit, into said mold.

2. The process as claimed in claim 1, wherein said mixture comprises between 0.5% and 5% by weight of said peroxide.

3. The process as claimed in claim 1, wherein said means for conveying said mixture in said plastic injection unit comprise a worm screw.

4. The process as claimed in claim 1, wherein at least 95% by weight, preferably 98% by weight, of said peroxide is decomposed before said mixture leaves said plastic injection unit.

5. The process as claimed in claim 1, wherein said plastic injection unites comprises at least two heating bands intended for heating said mixture contained in said plastic injection unit, between a first heating band positioned close to said material inlet of plastic into said plastic injection unit and said material outlet of plastic from said plastic injection unit, the temperature rise is between 20° C. and 60° C.

6. The process as claimed in claim 1, wherein the time interval between said mixture entering and leaving said plastic injection unit is less than 15 minutes, preferably less than 10 minutes.

7. The process as claimed in claim 1, wherein the plastic is selected from polypropylene, polyethylene, polyethylene terephthalate and polybutylene terephthalate.

8. The process as claimed in claim 1, wherein said peroxide is selected from the peroxides for which the 10-hour half-life temperature is greater than or equal to 90° C., preferably greater than or equal to 110° C.

9. The process as claimed in claim 1, wherein said mixture also comprises a reinforcement of the plastic, for example talc or glass fibers.

10. A plastic part obtained by injection molding, wherein said plastic part has, on the micrometer scale, at least two phases, a first phase being distributed in said plastic part in the form of grains, a joining phase coating and joining said grains of said first phase.

11. The plastic part as claimed in claim 10, wherein said joining phase exhibits crosslinking.

12. The plastic part as claimed in claim 11, wherein said crosslinking forms a continuous network throughout said joining phase.

13. The plastic part as claimed in claim 11, wherein certain crosslinked chains of said joining phase form an interphase between said joining phase and said first phase, said crosslinked chains being connected to the polymer chains of said first phase.

14. The plastic part as claimed in claim 10, obtained by a process for injecting a plastic part by means of a plastic injection unit comprising a material inlet, a material outlet toward a mold and means for conveying material between said material inlet and said material outlet, wherein said process comprises the following steps:
a mixture comprising pellets of a thermoplastic polymer and pellets of a peroxide is produced, said mixture comprising between 0.5% and 10% by weight of said peroxide;
said mixture is introduced into said material net of said plastic injection unit;
said mixture is conveyed in said plastic injection unit, while gradually raising the temperature of said mixture during the displacement thereof in said plastic injection unit, the temperature progression being such that at least 90% by weight of said peroxide is decomposed before said mixture leaves said plastic injection unit;
said mixture is injected, through said material outlet of said plastic injection unit, into said mold.

15. The plastic part as claimed in claim 10, said plastic part being a motor vehicle part.

16. The plastic part as claimed in claim 15, said plastic part being a motor vehicle luminous device part.

17. The plastic part as claimed in claim 16, said plastic part being a shield or a housing.

18. A vehicle luminous device comprising said plastic part as claimed in claim 16.

19. A process for injecting a plastic part by means of a plastic injection unit comprising a material inlet, a material outlet toward a mold and means for conveying material between said material inlet and said material outlet, wherein said process comprises the following steps:
a mixture comprising pellets of a thermoplastic polymer and pellets of a peroxide is produced, said mixture comprising between 0.5% and 10% by weight of said peroxide;
said mixture is introduced into said material inlet of said plastic injection unit;
said mixture is conveyed in said plastic injection unit, while gradually raising the temperature of said mixture during the displacement thereof in said plastic injection unit, the temperature progression being such that at least 90% by weight of said peroxide is decomposed before said mixture leaves said plastic injection unit;
said mixture is injected, through said material outlet of said plastic injection unit, into said mold, wherein said part is a part as claimed in claim 10.
